(19) United States
(12) Patent Application Publication
(10) Pub. No.: US 2013/0025199 A1
(43) Pub. Date: Jan. 31, 2013

(54) SUBSTRATE HAVING A POROUS SURFACE FOR VEGETATION

(71) Applicants: Robert Perroulaz, Geneva (CH); Laurent Daune, Annemasse (FR); Nathalie Monge, Geneva (CH); Jacques Kaufmann, Vanzy (FR)

(72) Inventors: Robert Perroulaz, Geneva (CH); Laurent Daune, Annemasse (FR); Nathalie Monge, Geneva (CH); Jacques Kaufmann, Vanzy (FR)

(73) Assignee: Haute Ecole Du Paysage, D'Ingenierie Et D'Architecture (HEIPA), Geneva (CH)

(21) Appl. No.: 13/521,950

(22) PCT Filed: Jan. 13, 2011
(86) PCT No.: PCT/IB2011/050152

§ 371 Date: Oct. 9, 2012

(30) Foreign Application Priority Data
Jan. 13, 2010 (CH) 00035/10

(51) Int. Cl. A01G 9/02

(52) U.S. Cl. 47/86

(57) ABSTRACT

The invention relates to a module for revegetating surfaces, for example walls, said module including at least one porous surface including interconnected porosities, said porous surface allowing the circulation of water and air and being used for sowing plants and anchoring the roots of said plants in said porosities, said roots growing in a substrate after having passed through said porosities.

### FIELD OF THE INVENTION

The present invention relates to a substrate for vegetation which may be used in the form of a panel, building block, tile or brick, for example.

More particularly, the present invention relates to a module permitting the juxtaposition of a porous wall with interconnected spaces with a substrate as a support for vegetation, in particular in a vertical position and in an urban environment.

### PRIOR ART

Substrates, for example modules, for vegetation are generally known in the prior art.

For example, the publication WO 2006/010846 A1 relates to a structure for a wall provided with vegetation designed for urban landscaping and for producing noise screens, partition walls, fencing around building sites, etc. Said publication discloses, more particularly, boxes of prismatic shape provided to be juxtaposed and/or superposed, each box being highly perforated and filled, for example, with compost in which the roots of vegetation planted in the compost are able to grow. Each box has wire-mesh or chain-link faces and is lined internally with a mat or fabric on its front and rear faces provided with perforations or slits through which the vegetation may be planted in the compost. More specifically, the front and rear faces of at least the boxes are covered on the inside with a mat or fabric fixed by stapling or bonding, which ensures the retention of the planting substrate. Plants are placed through the perforations or slits of the mat or fabric so that their roots grow in the planting substrate.

Said mat or fabric may fulfill various roles: namely, apart from retaining the compost, the retention of water or moisture, protection, a visual guide for the planting of vegetation according to a predetermined pattern, decoration, a lighting support, etc.

According to this known structure, the vegetation is thus directly planted in the substrate or compost and the mat or fabric only fulfills the roles indicated above.

The publication WO 2004/061255 A1 discloses a further substrate system. In this case it consists of a building block having two zones in which soil is placed where plants are able to grow directly.

The publication US 2008/0003445 A1 discloses a ceramic brick which comprises a shaped ceramic porous part to grow plants in combination with a support. The plants are directly planted in the porous ceramic, without the use of a substrate.

The document DE 39 32 644 discloses a further system to grow plants in a frame which may be hooked on vertically.

The publication US 2004/0010971 discloses a system in the form of a tube to grow plants. The tube is hollow and contains the substrate for the plants. The tube further comprises openings permitting the plants to grow out of the tube, said plants being sown in the substrate.

The publication US 2003/0196376 illustrates a further system in the form of a post combined with containers to grow the plants. The containers are shaped to contain soil, for example, and their external surfaces comprise openings to permit the passage of plants.

The publications DE 10 2005 063 133 A1, GB 2 412 558 A and DE 20 2004 000 438 U1 disclose further examples of substrates for vegetation.

### SUMMARY OF THE INVENTION

The object of the invention is to improve the known systems.

More particularly, an object of the invention is to propose a simple system to form elements with vegetation, for example walls/partitions to influence the urban environment, the thermal characteristics of a building, the control of rainwater, the acoustics and the pollution control.

The invention is useful for facades of all heights, made of materials which are porous and hybrid, which comprise inorganic substances or plants and/or are synthetic—or a material in the form of a soil mix applied to the wall and which might contain seeds. This is known as a “seeded wall”.

The invention also relates to a system which makes it possible to cultivate plants vertically or in a similar position.

According to the present invention, a “container module” is constructed, for example, from concrete or another non-porous material. The module comprises at least one face or wall which is porous, the spaces or porosities thereof being interconnected. The porous face is combined with an (inorganic and/or organic) substrate for the purpose of providing vegetation in new or existing facades. The module may take different forms, for example, in particular that of a building block, a tile, a panel or a brick according to the embodiments disclosed in detail in the present application.

The module according to the invention comprises a rigid shell, which is solid and self-supporting and comprises, as indicated above, at least one porous face or wall comprising interconnected spaces or porosities which permit the roots to be established. The provision of vegetation in the module is carried out by sowing in the spaces or porosities and the plants being directly rooted into the rigid surface where the porosities are interconnected, which forms the association of a volume of roots in the porous face and an environment where the roots grow and where water circulates in the substrate. As a result, the roots pass through an inert element, for example of 2 to 3 cm (depending on the thickness of the porous face), before finding water and food in the substrate, in contrast to what is implemented in the prior art, see for example WO 2006/010846 A1 cited above where the vegetation is planted directly into the compost. Thus the module according to the invention proposes a way of colonizing the spaces and porosities of the porous face by the vegetation which is planted there.

The vegetation grows naturally in the porosities of the face of the module. The size of the porosities does not permit seeds of ligneous plants to germinate on said surface.

Preferably, the module with the porous face(s) according to the invention has the following features:
its face(s) or porous wall(s) is(are) chemically inert (no chemical interaction with the environment);
its wall(s) consists(consist) of a frost-proof material (i.e. resistant to the cycles of freezing and thawing) and is heat-resistant, for example a ceramic or other equivalent material;
it comprises a surface which permits the establishment of roots in its porous surface. It forms an element of which (at least) one of the faces or wall is permeable, namely the face comprising the interconnected spaces or macro-porosities, said face being formed from a non-porous material with interconnected spaces which form said porous part;
for example, it is used to construct a wall of vegetation on an inorganic substrate;
it is formed by a rigid shell larger than 5 mm which is solid and self-supporting;
the permeability of the substrate is greater than that of the shell;
it forms a module, the layered structure and the materials thereof acting as an anti-noise wall.

Preferably, the size of the spaces (porosities) is 1 to 3 mm, which permits the establishment of roots in the porosities and the selection of the desired roots as a result of capillary action which is produced from the inside to the outside (and not in reverse). Other sizes of porosities are naturally possible depending on the circumstances.

Preferably, the module is entirely inorganic and solid and the interconnected spaces are smaller over the first 2-3 centimeters and wider over the last 4-5 centimeters of the thickness, which forms a porosity gradient.

Said porosity gradient illustrated in FIG. 8 allows the plants to be anchored in a first layer where the spaces are smaller and for water to circulate to the rear, irrigating the roots which pass through the porosities in the layer where the spaces are wider.

The principle of a porosity gradient may be extended to replace the substrate by a solid free-draining material, said material being the same as that used to form the porous face but with larger porosities. Typically, to produce such an embodiment of the invention, plates (for example ceramic plates) are juxtaposed, said plates having porosities or porosity gradients of different sizes.

The advantages of this entirely inorganic module according to the invention are, in particular, as follows:
it is formed from a single material;
the water is retained in the concave areas of the spaces or porosities;
hydroponic system;
soil-less system (in the case of the free-draining solid material).

Advantageously, the module is combined with an irrigation system. Preferably, the irrigation system is not in direct contact with the substrate but it is remote therefrom (for example approximately 5 mm from the soil). Thus the roots do not block up the drip-feeders of the watering system. Naturally, it is possible to use other equivalent means to avoid the flow being blocked by the roots.

The water which circulates in the substrate only escapes through the rigid shell in the form of vapor.

The advantages of the module according to the invention are numerous:
the module is resistant to UV, fungi and algae;
there is never any surface water but this is present in the soil or the compost (substrate);
maintenance is easy;
watering is carried out in the substrate contained in the module, for example by an irrigation system, the face with interconnected spaces remaining aerated and thus dry;
it is lightweight, whilst remaining rigid;
it permits shorter delivery times than other systems on the market;
it involves reduced transport costs relative to other systems on the market, in particular without the transportation of plants;
it forms an ecological system for the substrate in terms of primary energy (concrete).

The module according to the invention may be used in numerous ways, for example to form a wall. To form said wall, as a result, the desired number of modules according to the invention are stacked and an irrigation system as disclosed in more detail hereinafter is added thereto.

Naturally, said embodiments and dimensions are provided by way of non-limiting example and further embodiments are possible having different shapes but using the same principle as the present invention.

### BRIEF DESCRIPTION OF THE DRAWINGS

FIG. 1 shows in perspective an exploded view of the principle of the invention;

FIG. 2 illustrates a partial view in section of the principle of the invention;

FIGS. 3A to 3D illustrate an embodiment of a wall with building blocks according to the invention, FIG. 3C being a section along the axis A-A of FIG. 3B and FIG. 3D being a section along the axis B-B of FIG. 3B;

FIGS. 4A to 4D illustrate an embodiment in the form of tiles, FIG. 4C being a section along the axis A-A of FIG. 4B and FIG. 4D being a section along the axis B-B of FIG. 4B;

FIGS. 5A to 5D illustrate an embodiment in the form of panels, FIG. 5C being a section along the axis A-A of FIG. 5B and FIG. 5D being a section along the axis B-B of FIG. 5B;

FIG. 6 illustrates the principle of the porosity in the present invention;

FIG. 7 illustrates the principle of the distribution of water in the present invention;

FIG. 8 illustrates the porosity gradient between the outside and inside (substrate side).

### DETAILED DESCRIPTION

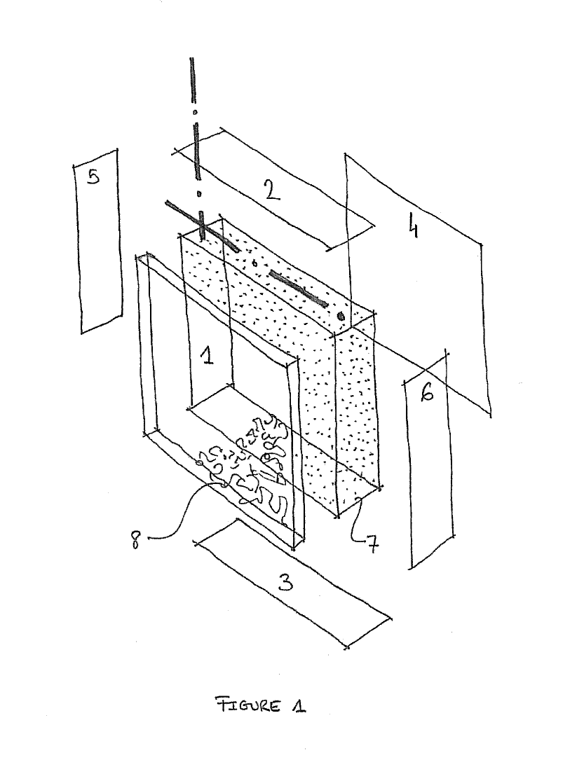

The principle of the invention is disclosed with reference to FIGS. 1 and 2. The module has the shape of a building block, as illustrated by way of example. The module according to the invention thus comprises six faces 1, 2, 3, 4, 5, and 6 as shown in FIG. 1. A first face 1 is formed by an interconnected porous material. Preferably, the faces 2 and 3 are permeable but act as containers (for a substrate 7), the face 2 further permitting the support of a horizontal water supply. The faces 4, 5 and 6 (rear and vertical sides in FIG. 1) are sealed and may be of different types. For example, the face 5 (or 6 or both) may contain a vertical water supply.

According to a variant, in the case of providing vegetation on two faces (in this case faces 1 and 4, for example), said faces 1 and 4 are formed in a porous interconnected material according to the principle of the invention.

To produce the face of porous material, a material is used with interconnected porosities (for example of 2 to 3 mm) permitting the circulation of water, air and the anchoring of the roots.

To produce such an interconnected porous material, it is possible to use a ceramic powder combined with a second material which is subsequently dispensed with, thus forming this interconnected porous structure. Reference may be made, for example, to the teaching of the following publications: EP 1 140 731, U.S. Pat. No. 4,024,212 and WO 2006/018537 for the production of such porous faces.

Once the porous face/wall is produced, it is possible to join it to the concrete elements (for example) by pouring said concrete into the porosities of the porous part. The porous face or wall may thus have any shape which is useful or necessary depending on the desired use and it is possible to fix it to parts forming the remainder of the module by using the spaces or porosities. Naturally, further equivalent fixing means are possible.

Moreover, according to the present invention, the porous face is sown with seeds. Thus, the porosities allow the seeds to germinate. The concave areas where water and air circulate allow the plant to be rooted in this face and the roots then seek water and the nutrients in the substrate 7 by following the porosities or interconnected spaces.

According to the invention, the porosity of the face 1 is dimensioned so as to be sufficiently large for the plants to be able to take root, but prevents spontaneous ligneous vegetation from being established (trees and shrubs of which the roots may damage the structure of the building).

According to the invention, the basic structure of the module may comprise three elements (see FIG. 2):

1. a porous material forming the interconnected porous face (for example 1 in FIGS. 1 and 2) which permits the plant to be anchored and to retain the substrate 7;

2. a substrate 7 which permits the circulation of air, nutrients and water necessary for the growth of the plants;

3. plants 8 suitable for the quantity of substrate available, the climate, the aspect, the vertical situation and the available water.

This structure allows the vegetation to live naturally, healthily and over a long period. It withstands environmental stresses (wind, frost and heat, etc.) and has acoustic and thermal properties.

Naturally, the sizes and shapes of the material and planting may be adapted to the requirements of the location (the orientation and reasons for the planting, composition, etc.)

The advantages of the structure according to the invention are numerous, in addition to those already mentioned above:
industrial manufacture of the product;
the product is able to be easily handled (for example in the form of a building block or other equivalent element);
it is easy to use;
little maintenance is required;
the properties of the soil are conserved, said material which is permeable to air and water allows the roots of the plants to be anchored, whilst freeing the soil from the effects of gravity.

Various uses and interpretations of the system may be combined:
dynamic-evolving system: the vegetation is selected according to the climate, their aspect (shady or sunny) and the type of management (extensive or intensive). Thus the plants, the thickness of the substrate and the water consumption vary.
“extensive/autonomous” system: porous material with a small amount of substrate. Very low water requirement and very little maintenance. Lightweight system.
it is also possible to conceive that the porous material is sufficient for certain plants, which have few requirements in terms of water and maintenance, to be established.
“evapo-transpiration” system: porous material and larger substrate layer. Permits a wider choice of plants and the ability to influence the urban climate more effectively (more evapo-transpiration).

As indicated above, the system according to the invention is preferably conceived in the form of a module, each module being able to be used independently. It has all the necessary elements for providing vegetation thereon, namely: a porous face connected to a substrate and vegetation and a structure depending on its predicted use.

The structural system provides that the substrate is contained in the module whilst water is permitted to circulate.

Different sizes may be available, depending on the planned use, in particular.

It is possible for it to be used in different ways, according to different variants and with different plants.

It is manufactured industrially, sown with seeds in the factory or nursery and mounted in situ.

By way of non-limiting examples, the module of the invention may take the following forms:

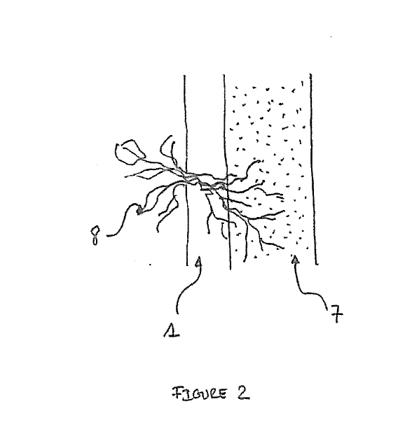

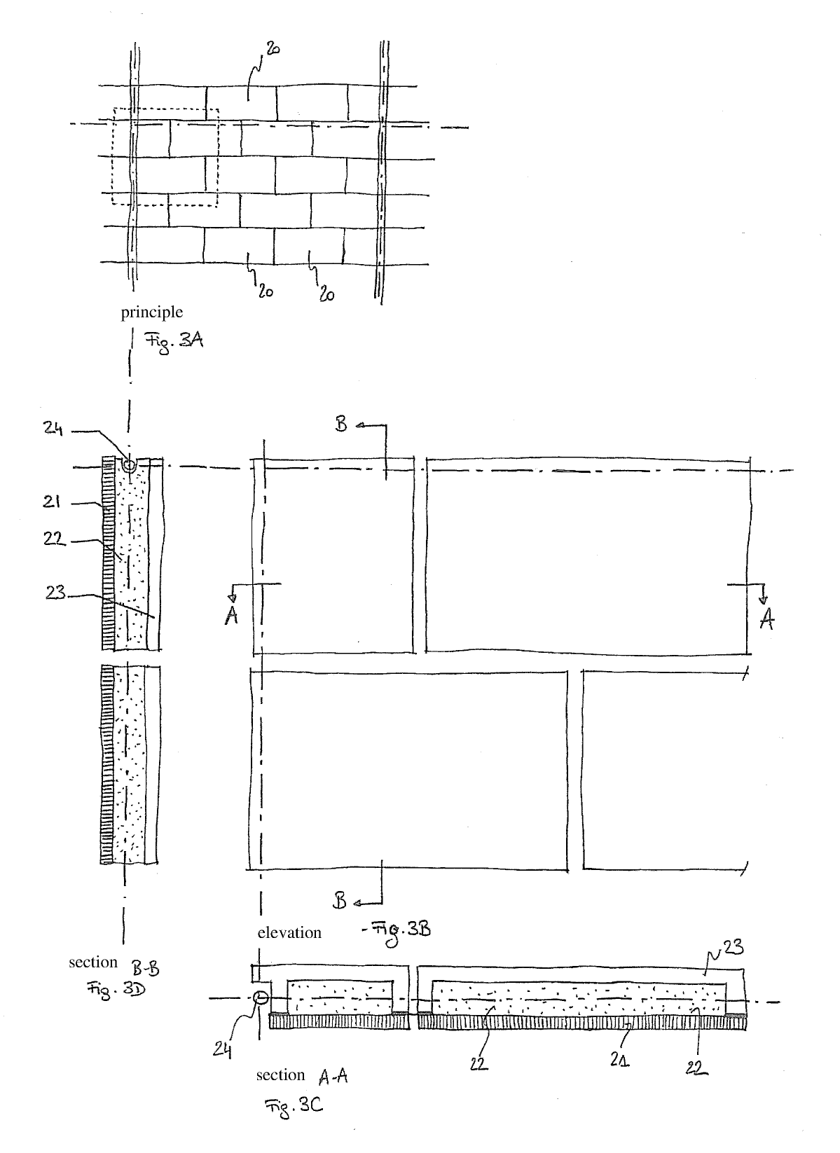

A building block (see for example FIGS. 1 and 2) of which one of the facings, face 1 or faces 1 and 4, is/are formed from a porous material with interconnected spaces in all spatial directions. The “building block” elements are handled easily, stacked up and juxtaposed. The internal volumes are continuous from top to bottom. Its rigidity also provides it with a structural function. FIG. 3A shows the principle of a wall formed from building blocks 20 according to the present invention.

More specifically, FIG. 3A is a front view of part of the wall composed of building blocks 20 in which the distribution of water is illustrated schematically by dashed-dotted lines. FIG. 3B is a view in elevation of a part of the wall, FIG. 3C is a sectional view along a horizontal plane A-A and FIG. 3D is a view in section along a vertical plane B-B.

More specifically, FIGS. 3C and 3D show the porous face 21, the substrate 22, the container 23, for example corresponding to the faces 3-6 of FIG. 1, and the irrigation system 24 which is both horizontal and vertical (see dashed-dotted lines of FIGS. 3A-3D).

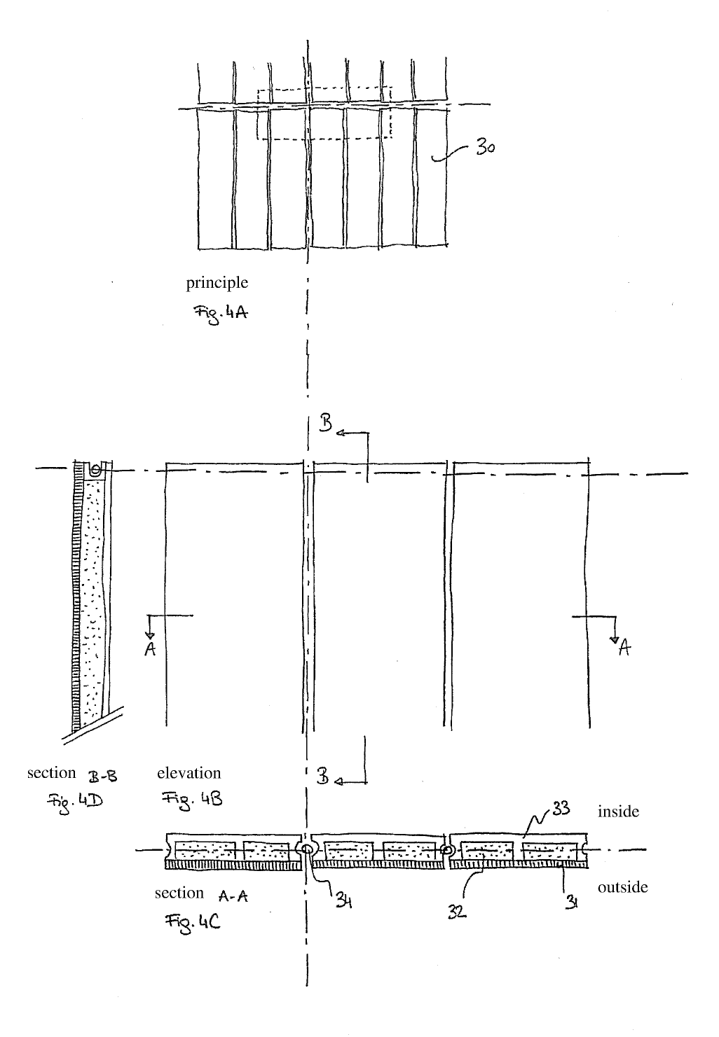

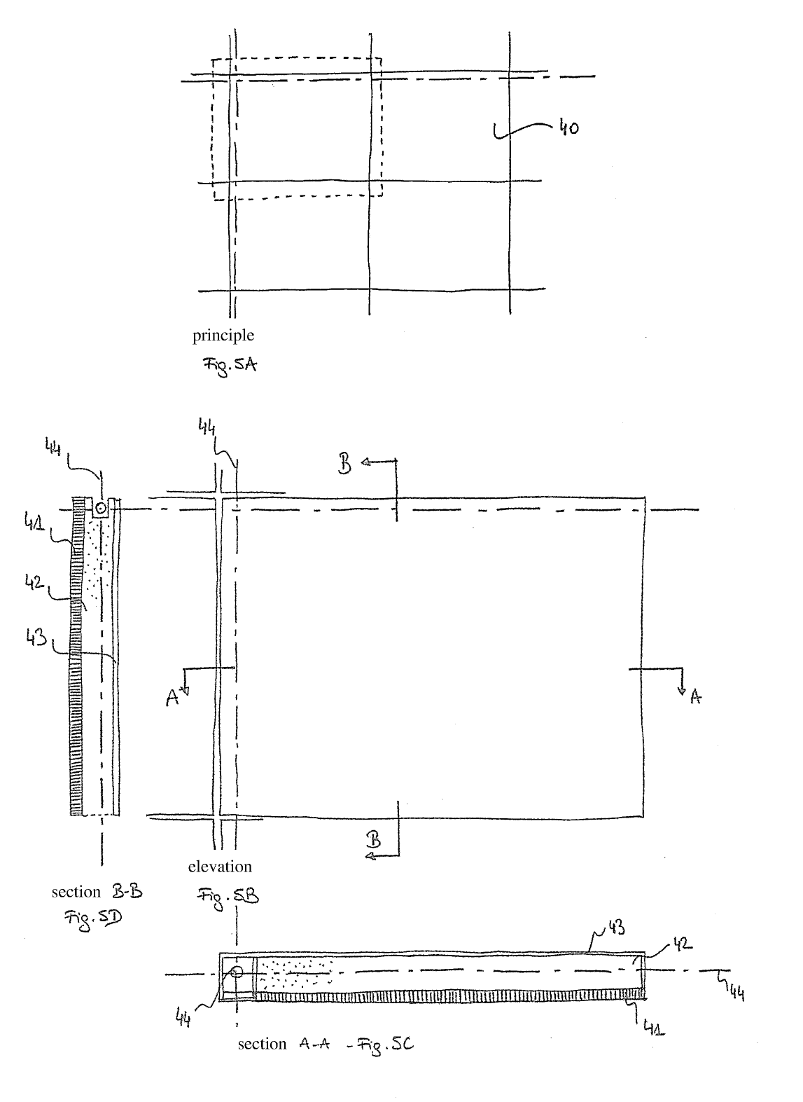

FIGS. 4A to 4D illustrate an embodiment in the form of a tile 30 of which the front face is composed of a porous material with interconnected spaces in all spatial directions, with a system for hooking onto the wall. According to the principle of the invention, the tiles comprise a porous face 31, a substrate 32, a container 33 and an irrigation system 34 (shown schematically by dashed-dotted lines of FIGS. 4A-4D and 4C).

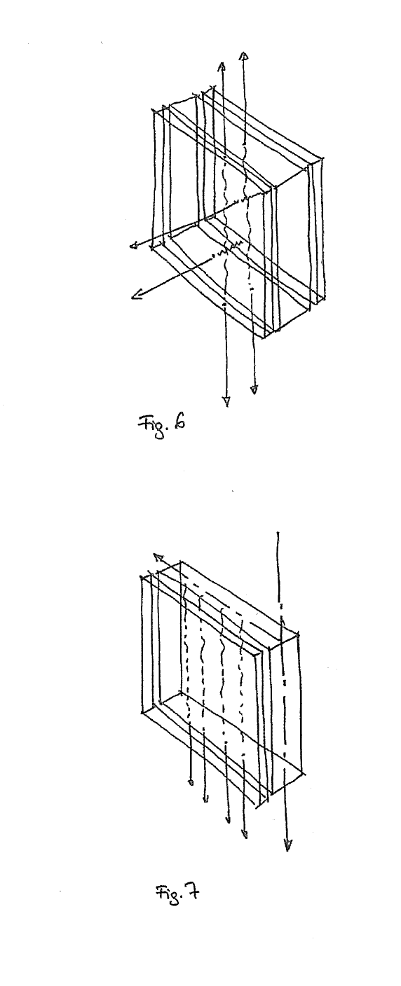

FIGS. 5A to 5D illustrate an embodiment in the form of a panel 40 stapled to a wall or intermediate structure which might comprise the face 41 formed from a porous material with interconnected spaces in all spatial directions. According to the present invention, the panel further comprises a substrate 42, a container 43 and an irrigation system 44 (shown schematically by dashed-dotted lines in FIGS. 5A-5D).

As indicated above, the module may be independent, provided with vegetation on one or both faces depending on its use and on the different embodiments disclosed above.

Preferably, a drip-type irrigation system is incorporated in the principle. The water circulates within the depth of the substrate, the excess being collected and reused, which limits wastage. The irrigation system is shown schematically in the figures disclosed above, as explained, and comprises for example pipes or conduits 24, 34, 44 with openings (for example slots) permitting the passage of the irrigation means (for example water) into the substrate. Further equivalent systems are naturally conceivable.

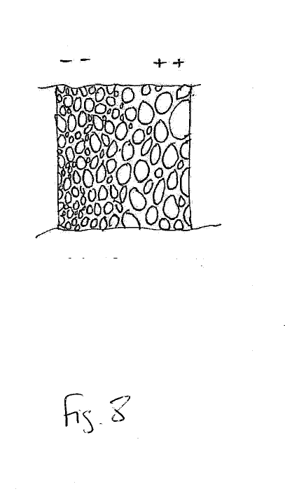

FIG. 6 illustrates the principle of the porosity in the module according to the invention. As may be seen, the flow of air (shown schematically by the arrows) may circulate in all directions.

FIG. 7 illustrates the principle of the distribution of water (as also shown in FIGS. 3A-3D, 4A-4D and 5A-5D). As indicated, the distribution is carried out in two perpendicular (or approximately perpendicular) planes, namely in a horizontal plane and a vertical plane. Naturally, depending on the position of the module (whatever the embodiment thereof) said planes may not be strictly horizontal and vertical.

The system permits improved insulation of the facade, thermal protection (both in summer and in winter) and, as a result, allows an energy saving.

The constituent elements (depth of substrate, choice of vegetation, water flow, etc.) are selected according to the orientation of the wall or aesthetic and ecological requirements.

According to variants, it is possible to color the porous material or further faces of the module. The use of a translucent material permits lighting of the facade by light-emitting diodes or other equivalent means.

The external porous surface may be planar or shaped.

The module may be used vertically, obliquely or horizontally.

Naturally, the examples given above are by way of illustration and do not have to be understood as limiting the scope of the present invention, for which variants are possible. Different embodiments may, for example, be of any size, determined for example by the application.

Moreover, the concept of a face or wall used to define the porous part of the module has to be understood as covering both an entire face or wall of the module but also a partial face or wall of the module. In this case, a given face or wall may have a porous part (according to the present invention, i.e. which comprises vegetation) and a non-porous part.

As disclosed above, the module may also have more than one porous face or wall according to the invention.

1. A module for providing vegetation on surfaces, for example walls, said module comprising at least one porous face comprising interconnected porosities, said porous face permitting the circulation of water and air and being used to sow seeds of plants and anchor the roots of said plants in said porosities, said roots growing in a substrate after having passed through said porosities.

2. The module as claimed in claim 1, in which said porous face comprises a porosity gradient along which the interconnected spaces are smaller on the external side of the module and wider on the internal side of the module.

3. The module as claimed in claim 1, said module being formed from concrete or any other equivalent material.

4. The module as claimed in claim 1, in which the size of the porosities is in the order of at least 0.5 mm.

5. The module as claimed in claim 1, in which the size of the porosities is 1 to 3 mm.

6. The module as claimed in claim 1, comprising two or more porous faces.

7. The module as claimed in claim 1, in which the substrate is formed from soil and/or compost or a solid free-draining material.

8. The module as claimed in claim 7, in which the solid free-draining material is the same as that used to form the porous face, said solid free-draining material comprising interconnected porosities.

9. The module as claimed in claim 8, in which the interconnected porosities of said solid free-draining material are larger than those of the porous face, the module being formed by a juxtaposition of elements, the porosities thereof being of different sizes.

10. The module as claimed in claim 1, combined with an irrigation system.

11. The module as claimed in claim 10, in which the irrigation system acts in two approximately perpendicular directions.

12. The module as claimed in claim 10, in which the irrigation system comprises pipes with openings, said pipes being located at a distance of approximately 5 mm from the substrate to avoid being blocked by roots.

13. The module as claimed in claim 1, having the shape of a building block with six faces (1, 2, 3, 4, 5, 6), at least one of said faces forming said face with interconnected porosities (1) and the substrate being positioned inside said building block.

14. The module as claimed in claim 1, having the form of a tile.

15. The module as claimed in claim 1, having the form of a panel.

16. A structure comprising at least one module as claimed in claim 1.
